(19) United States
(12) Patent Application Publication
(10) Pub. No.: US 2007/0079341 A1
(43) Pub. Date: Apr. 5, 2007

(54) DVD MULTI-ROOM PLAYBACK AFTER HEADEND CONVERSATION

(75) Inventors: Samuel H. Russ, Lawrenceville, GA (US); William E. Wall, Atlanta, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(73) Assignee: SCIENTIFIC-ATLANTA, INC., Lawrenceville, GA (US)

(21) Appl. No.: 11/164,337

(22) Filed: Nov. 18, 2005

Related U.S. Application Data
(63) Continuation-in-part of application No. 11/163,107, filed on Oct. 5, 2005.

(51) Int. Cl. H04N 7/16; H04N 7/173

(52) U.S. Cl. 725/89; 725/134; 725/142

(57) ABSTRACT

DVD multi-room playback after headend conversation. The DVD content is saved to a hard drive of a primary device in a networked multi-room system. While the content is being saved to the hard drive, the headend is contacted to secure permissions, pay royalties, etc. for the copyrighted material. The movie saved on the primary device can then be retrieved by any of the remote devices by accessing the program guide or the recorded programs list.

### CROSS-REFERENCE TO RELATED PATENT APPLICATIONS

The present application is a continuation-in-part (CIP) of U.S. patent application “DVD Playback over Multi-Room” having Ser. No. 11/163,107, which was filed on Mar. 31, 2003, the disclosures and teachings of which are hereby incorporated by reference.

### FIELD OF THE INVENTION

This invention relates in general to broadband communications systems, and more particularly, to playing a DVD to multiple set-top boxes in a networked multi-room system.

### DESCRIPTION OF THE RELATED ART

Broadband communications systems, such as satellite and cable television systems, are now capable of providing many services in addition to analog broadcast video. In implementing enhanced programming, the set-top box (STB), otherwise known as a device, has become an important computing device for accessing various video services. In addition to supporting traditional analog broadcast video functionality, many STBs also provide other functionality, such as, for example, an interactive program guide (IPG), video-on-demand (VOD), subscription video-on-demand (SVOD), and functionality traditionally associated with a conventional computer, such as e-mail. Trick play features such as pause, fast forward, rewind, skip ahead, or skip back have also been included. While watching a presentation, users now have enhanced control of their viewing experience.

Recently, new functionality has been added to conventional STBs—namely the ability to play a DVD and record an incoming video stream in digitized form onto a mass storage device, such as a hard disk drive, play back that recorded video as desired by the user, and transfer the video to a removable, archival storage device possibly using a DVD recorder. This functionality has become known as a “digital video recorder” (DVR) or personal video recorder (PVR) and is viewed as a superior alternative to conventional video tape recorders for capture and subsequent playback of programming content.

A STB is typically connected to a television set and located at the home of the cable or satellite system subscriber. Since the STB is located at a subscriber's premises, it typically may be used by two or more users (e.g., household members). Television has become so prevalent in the United States that the typical household may have two or more television sets, each television set requiring its own STB if the subscriber wishes to have access to enhanced functionality.

A networked multimedia system (NMS) is described in copending U.S. patent application Ser. No. 10/342,670, filed Jan. 15, 2003, the disclosure and teachings of which are hereby incorporated by reference. The NMS allows a plurality of remote devices in the premises to be locally networked (i.e., home-networked). One of the remote devices typically acts as the server or primary device (i.e., the primary set-top box (STB)) in the NMS. The primary device receives and forwards upon request broadband multimedia presentations (e.g., analog or digital television channels (i.e., audio/video signals), IP signals, video-on-demand (VOD) signals, administrative signals, etc.) throughout the local network to the plurality of remote devices (i.e., client devices). Furthermore, the remote devices are each capable of requesting and seamlessly receiving from the primary device resident presentations, such as a stored or recorded presentation, the interactive program guide, or the network guide, for example.

This new technology also allows multiple users in a household to access material on the primary set-top box through remote set-top boxes. To increase functionality, there is a need for the ability to play a DVD at the primary device and then view the presentation, or movie, at multiple remote devices either simultaneously or at varying times.

### BRIEF DESCRIPTION OF THE DRAWINGS

The invention can be better understood with reference to the following drawings. The components in the drawings are not necessarily drawn to scale, emphasis instead being placed upon clearly illustrating the principles of the invention. In the drawings, like reference numerals designate corresponding parts throughout the several views.

FIG. 1 is a simplified block diagram depicting a non-limiting example of a conventional broadband communications system with a networked multi-room system (NMS).

FIG. 2 illustrates a non-limiting example of one embodiment of an interactive program guide (IPG), which is suitable for use in the NMS of FIG. 1.

FIG. 3 illustrates the IPG of FIG. 2 further including functionality listings, such as a DVD.

FIG. 4 illustrates an alternative embodiment of the IPG of FIG. 2 further including functionality listings, such as a DVD and DVD menu options.

FIG. 5 illustrates a non-limiting example of a recorded programs list screen that may be presented to a remote device via the NMS of FIG. 1.

FIG. 6 illustrates a non-limiting example of a DVD menu screen.

### DETAILED DESCRIPTION

The embodiments of the invention can be understood in the context of a broadband communications system and a local network system. Note, however, that the invention may be embodied in many different forms and should not be construed as limited to the embodiments set forth herein. For example, transmitted broadband signals may include at least one of video/audio, telephony, data, or Internet Protocol (IP) signals, to name but a few. Furthermore, remote devices included in the local network system receiving the transmitted broadband signals may include a set-top terminal (STB), a television, a computer, a personal digital assistant (PDA), or other display device. Moreover, in accordance with the present invention a multi-room interactive network guide can have various features, functions, and presentations when displayed. All examples given herein, therefore, are intended to be non-limiting and are provided in order to help clarify the description of the invention.

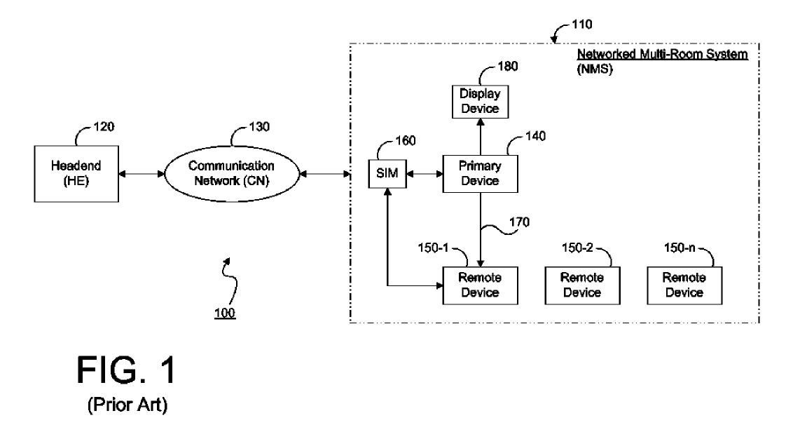

FIG. 1 is a simplified block diagram depicting a non-limiting example of a conventional broadband communications system 100. In this example, the communications system 100 includes a local networked multi-room system (NMS) 110 that is coupled to a headend (HE) 120 via a communications network (CN) 130. The CN 130 may be any network that is suitable for carrying, preferably downstream and upstream, broadband multimedia signals, such as audio/video signals, IP signals, telephony signals, or data signals to name but a few. The CN 130 may be, for example, a hybrid fiber/coax (HFC) network, a fiber-to-the-home (FTTH) network, a satellite network, or a fixed wireless network (e.g., MMDS), among others.

The HE 120 may include one or more server devices for providing broadband signals, such as video, audio, and/or data signals, to a primary device 140 via the CN 130. The HE 120 and the primary device 140 cooperate to provide a user with a variety of services. The services may include, for example, analog or digital broadcast television services and channels, video-on-demand (VOD) services, and/or pay-per-view (PPV) services, among others. Each broadcast television channel typically provides a sequence of television presentations corresponding to a television station (e.g., ABC, NBC, CBS, or FNN) and is typically identified by a channel number (e.g., channel 2, channel 3, channel 4) that is available to a user at all times. Additionally, PPV services are typically transmitted to the primary device 140 at all times, but can only be viewed on the primary device 140 as provisioned. On the other hand, the primary device 140 typically requests a VOD service and, subsequently, the HE 120 transmits the presentation downstream to the primary device 140.

The NMS can include a router, but as shown in FIG. 1, the NMS 110 includes a splitter/isolator module (SIM) 160 that receives downstream broadband signals from the HE 120 and subsequently provides the downstream signals to the primary device 140 or to both the primary device 140 and any one or all of the remote devices 150-1 to 150-n depending on the implementation. Upon command from at least one of the remote devices 150-1 to 150-n, the primary device 140 may also forward selected real-time downstream signals and/or stored content signals to the requesting remote device 150-1, for example, via the SIM 160. The remote device 150-1 communicates with the primary device 140 by sending reverse control/command signals via coaxial cable requesting stored presentations, real-time signals, or the network guide. Other wired mediums, such as telephone lines or data cables, may be used so long as the transport format accommodates the desired transmission medium. The remote devices 150-1 to 150-n have access to all of the primary device 140's hardware and software functionality, along with receiving downstream signals directly from the headend via the SIM 160. Therefore, the remote devices 150-1 to 150-n may have limited resources, such as not including a storage device in order to record and store a presentation, thereby decreasing the overall costs to the service provider and the subscriber while offering advanced services to all of the remote devices 150-1 to 150-n that are networked to the primary device 140.

Furthermore, the primary device 140 may also directly provide signals, such as analog and digital channels, stored presentations, or the network guide to name but a few, to a coupled display device 180, which may be, for example, a television, computer, or PDA (personal digital assistant), among others. The primary device 140 may transmit signals to and receive control signals from the display device 180 via wireless devices (e.g., RF or IR devices) or a wired medium (e.g., coaxial cable, power lines, or telephone lines). It will also be appreciated that the primary device 140 may be incorporated in the display device 180.

The primary device 140, in accordance with one embodiment of the present invention, includes a processor, a tuner system, a storage device, a modulator, and a remote device communications receiver. Each of the remote devices, such as the remote device 150-1, may be identical to the primary device 140 but share the storage device contents of the primary device 140. Alternatively, the remote device 150-1 may be a simplified or conventional version of the primary device 140. A processor and a tuner system, which may be a simplified processor and only one tuner, may be included to extract channels from the received downstream broadband signals. Additionally, decryptors and decoders may be included to decode encoded signals for proper processing and display. Preferably, the remote device 150-1 includes a user input receiver, such as an IR receiver or an RF receiver that receives signals from a remote control, such as an IR remote control or an RF remote control. The remote control is not required and any user input device could be incorporated in the remote device 150-1.

In the event that the remote device 150-1, upon user input, requests a presentation, a reverse command signal is transmitted from the remote device 150-1 to the primary device 140 via the SIM 160. The remote device command receiver receives and demodulates the command signal according to its transmission method, such as frequency-shift keying (FSK) or on-off keying (OOK) transmission. The processor subsequently receives the demodulated command signals indicative of the requested action (e.g., requesting a presentation) and in accordance therewith instructs the tuner to tune to, for example, a channel carrying a real-time downstream signal, or the processor may retrieve a stored presentation from the storage device. The presentation's content signals are then provided to the modulator, which modulates the selected presentation prior to forwarding to the SIM 160. A preferred embodiment of the present invention uses a quadrature amplitude modulation (QAM) modulator, which may be used for effectively transmitting signals over coaxial cable in a cable television environment.

The presentations stored in the storage device of the primary device 140 include program identifiers (PIDs), which may be indexed and stored as a table in the primary device's memory. The remote devices 150-1 to 150-n may watch a single stored presentation by remapping the PID value of the stored program to a different PID value prior to modulation. PID remapping comprises replacing the PID in the header of the packet with a different value. PID remapping can be accomplished with a variety of methods, such as, for example, by using a table, an algorithm, or hardware. In this manner, the single stored program basically remains in the storage device of the primary device 140, while the transmitted presentation is a version of the stored presentation having a remapped PID value.

If two remote devices request the same presentation, a version of the presentation on the primary device 140 is sent to each requesting remote device 150-1 to 150-n. Each version will have a different PID value. The processor in the primary device 140 alerts the requesting remote device, such as remote device 150-2, of the expected remapped PID value in order to ensure the remote device 150-2 extracts the requested presentation from a signal sent by the primary device 140.

To play a DVD movie from the primary device 140 to one or more remote devices 150-1 to 150-n or a portable device simultaneously or at varying times, a portion or all of the content from the DVD must first be copied to the hard drive of the primary device 140. The primary device 140 transcodes the desired content of the DVD from an MPEG program stream to an MPEG transport stream and creates a PID value for the transport stream. With the presentation in an MPEG transport stream, trick play features are available while viewing the presentation. Also, the DVD presentation may have an encryption scheme, such as CSS encryption, which must be decrypted and then encrypted with a second encryption scheme particular to the NMS 110, such as the multi-room 3DES encryption, to ensure that the content remains secure over the NMS 110. The primary device 140 contacts the HE 120 to provide security and viewer data collection after copying the presentation to the primary device 140's hard drive.

During the copying and transcoding process, the HE 120 may be contacted by the primary device 140 to secure permissions, pay royalties, etc., as negotiated by the cable operator and the DVD copyright holder. Alternatively, one of the remote devices 150-1 to 150-n or a portable device coupled to the NMS 110 could request permission itself or via the primary device 140. This could be a service that automatically secures permissions and the appropriate fees are paid per DVD or as a subscription for a set rate. Instead of a service, the user could be required to enter the appropriate information and obtain the necessary permission each time a DVD is copied to the hard drive of the primary device 140. The number of times the DVD can be played in a networked multi-room system or on a portable device and the length of time the movie can be stored on the primary device 140 could also be predetermined and charged accordingly. While requesting and receiving permission from the HE 120, the HE 120 could also download additional material relevant to the movie and populate the VOD menu with similar or related movies.

The primary device 140 could contact the HE 120 to secure supplementary permissions when an additional device requests to play the presentation that is being copied or has been copied to the hard drive of the primary device 140. In another embodiment, the HE 120 could be contacted prior to the presentation being copied to the hard drive of the primary device 140. Additional devices can include remote devices 150-1 to 150-n or portable devices such as laptops, PDAs, portable video players, etc.

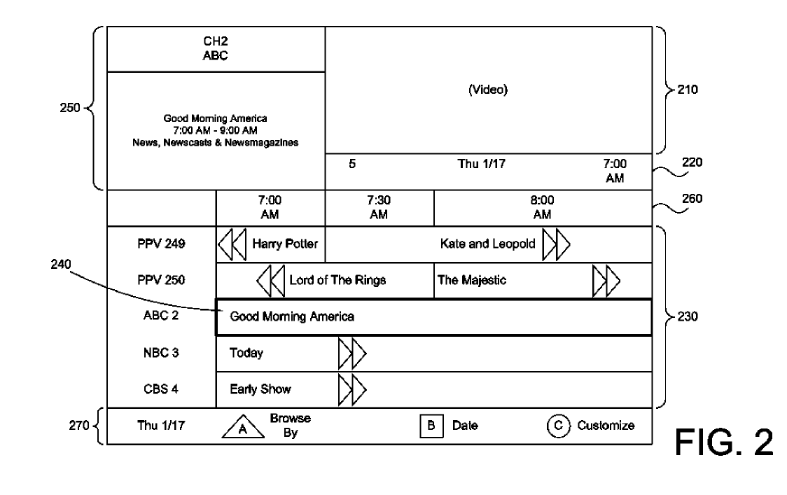

FIG. 2 illustrates a non-limiting example of an interactive program guide (IPG) screen 200 that is suitable for use in the NMS 110 of FIG. 1. The IPG screen 200 may be presented in response to user input that may be provided via the activation of a guide key on the remote control. In the top right of the IPG screen 200, video corresponding to the channel to which the primary device 140 is currently tuned may be displayed in the video area 210 for scaled video. Immediately below the video area 210 is an information banner 220 for displaying the channel number corresponding to the channel to which the primary device 140 is currently tuned, the current day and date, and the current time.

In one embodiment, arrow buttons on the remote control can be used to scroll through a main presentation listing 230 and to highlight a desired presentation 240. The top left portion of the IPG screen 200 is a detailed focus area 250 that includes detailed information for a currently highlighted presentation 240. The detailed focus area 250 may include channel number, channel description, presentation name, duration of the presentation, and/or any episode information or rating. As a user scrolls in time across a boundary 260, the day and date indications displayed in various areas are updated. The area 270 at the bottom of the IPG screen 200 also indicates the current day for which presentation listing data is being displayed as well as information about the current functions of the optional “A,” “B,” and “C” keys that may be on the remote controls and are used in conjunction with the IPG. Further information regarding an interactive program guide can be found in copending U.S. patent application Ser. No. 10/212,017 filed on Aug. 2, 2002, the disclosure and teachings of which are hereby incorporated by reference.

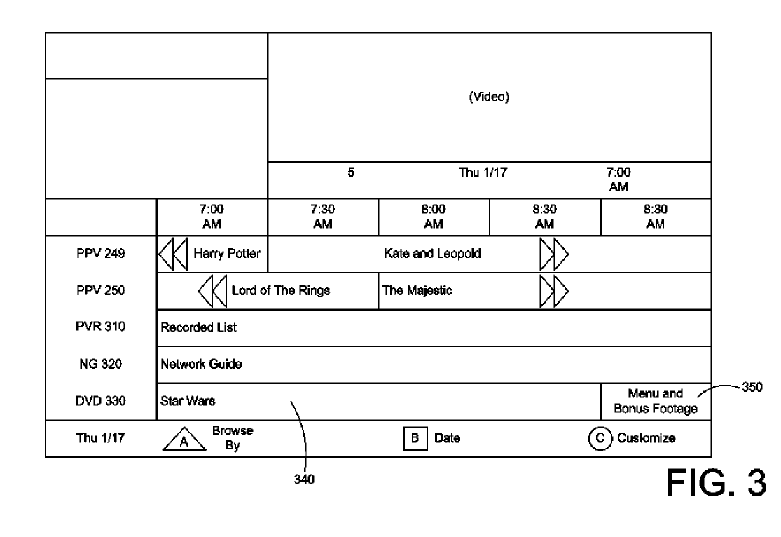

FIG. 3 illustrates an IPG 300 including functionality listings, such as a personal video recording (PVR) listing 310 and a network guide listing (NG) 320, and a channel listing for a DVD 330. Highlighting and selecting a movie 340 accesses for example, Star Wars, which has been recorded from a DVD to the hard drive of the primary device 140 to begin playing the movie 340. Also shown as a presentation under the DVD channel listing 330 at a later time is the menu and bonus footage 350. By offering both the movie 340 and the menu and bonus footage 350 as options for the DVD channel listing 330, the user can quickly locate the desired material.

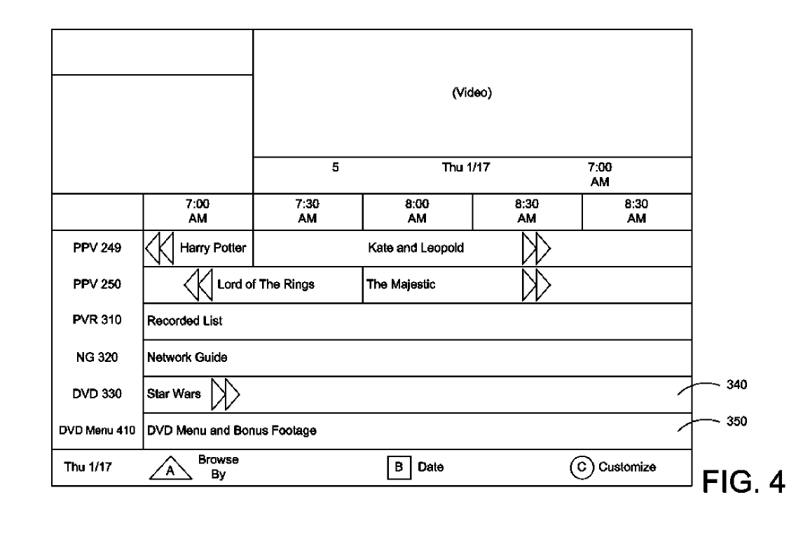

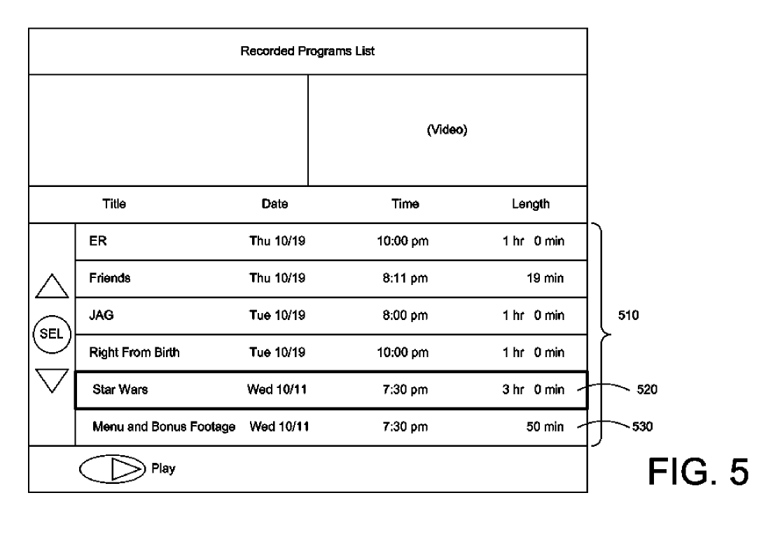

FIG. 4 illustrates an alternative embodiment of an IPG 400 including functionality listings, such as the DVD channel listing 330 and a separate DVD menu listing 410. Unlike the previous embodiment shown in FIG. 3, which shows the movie 340 and the menu and bonus footage 350 appearing on the same channel 330 at different times, this embodiment displays the movie 340 and the menu and bonus footage 350 as different channels 330 and 410, respectively. This allows the user to quickly begin playing the movie 340 or to choose to view the menu and bonus footage 350 that normally accompanies a DVD. Highlighting and selecting the PVR listing 310 accesses a recorded programs list screen 500 as shown in FIG. 5. Alternatively, the user can select the channel number using number keypads on the remote control, such as entering numbers 310 or 330.

Still referring to FIG. 5, the interactive recorded programs list screen 500 shows a portion of a recorded programs list 510 that may be presented to the remote devices 150-1 to 150-n via the NMS 110 of FIG. 1. The recorded programs list screen 500 displays a recorded programs list 510 that includes all the recorded programs along with, for example, the title, the recording date and time, and the length of the program. If a movie from a DVD has been copied and saved to the hard drive of the primary device 140, the movie can appear on the recorded programs list screen 500 in the recorded programs list 510, as for example Star Wars 520. A separate entry 530 on the recorded programs list 510 can appear for the menu and bonus footage corresponding to the movie 520. A presentation in the highlighted program line 520 can typically be selected for viewing by pressing a select button or a play button on a remote control. When a remote device 150-1, for example, requests a list of the recorded programs, the processor accesses the recorded programs list 510, which is stored in memory, and subsequently forwards the content signals indicative of the recorded programs list 510 to the modulator for modulation and transmission to the requesting remote device 150-1.

For example, a presentation 520 entitled Star Wars, from a DVD, was saved to the hard drive of the primary device 140 on Wednesday, October 11 and is three hours in length. After the user selects the presentation 520, the remote device 150-1 sends a reverse command signal that is indicative of the selected presentation (i.e., Star Wars) to the remote command receiver via the SIM 160. The processor extracts Star Wars from the storage device using an identifier. The presentation 520 is subsequently modulated and transmitted to the SIM 160 for delivery to the remote device 150-1. The requesting remote device 150-1 tunes to the modulator frequency and waits for the response (i.e., the presentation 520 entitled Star Wars).

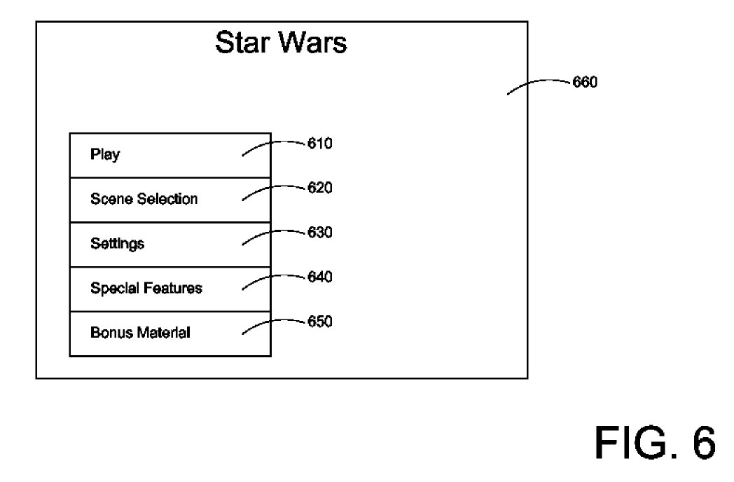

FIG. 6 illustrates one embodiment of a root menu 600 typical on store bought, or prerecorded, professional DVDs. Options within the root menu 600 typically include play 610, scene selections 620, settings 630, and special features 640. The menu 600 can contain an option for bonus material 650, which could be inserted material such as, contests, seasonal promotions, commercials, previews, movie prequels/sequels, or other additional content or inserted material. The primary device 140 will contact the HE 120 to determine what relevant material has been previously downloaded and stored at the HE 120 and can be inserted into the DVD menu 600. Alternatively, the inserted material could be downloaded and stored elsewhere such as on a server distributed in the network or at one of the set-top boxes in the NMS 110. The DVD could also have PC readable files, such as HTML documents or executable files that pertain to the tuned presentation. For example, for the movie Star Wars, background information on the characters and games associated with the movie could be included. The existing menu screen 600 could also be altered to have added or replaced material such as a commercial, logo, or a picture of a product as a background 660.

Advertising opportunities are created by altering the movie on the primary device 140. The movie has been indexed into chapters for the scene selection option, and ads or commercials could easily be inserted to correspond with the beginning or end of one or more chapters. The commercials could have been previously downloaded and saved to the primary device 140, one of the remote devices 150-1 to 150-n, or the HE 120. Depending on user preferences or the DVD being played, corresponding commercials could be chosen and displayed. For example, during the presentation Star Wars, the inserted commercials could be for Star Wars merchandise. Therefore, commercials to be inserted could be selected based upon the original content of the DVD. The same commercials could be played on all devices 140 and 150-1 to 150-n or the commercials could be tailored to the user of each particular device based upon user preferences or parental control settings. For example, the chosen commercials could be different for each device 140 or 150-1 to 150-n playing the movie from the DVD.

It should be emphasized that the above-described embodiments of the invention are merely possible examples, among others, of the implementations, setting forth a clear understanding of the principles of the invention. Many variations and modifications may be made to the above-described embodiments of the invention without departing substantially from the principles of the invention. All such modifications and variations are intended to be included herein within the scope of the disclosure and invention and protected by the following claims. In addition, the scope of the invention includes embodying the functionality of the embodiments of the invention in logic embodied in hardware and/or software-configured mediums.

What is claimed is:

1. A method for obtaining permission to transmit a prerecorded presentation from a DVD over a networked multi-room system (NMS), said method comprising the steps of:
contacting a headend from the NMS to secure permission for use of said prerecorded presentation; and
in response to securing permission, transmitting at least a portion of said prerecorded presentation stored on a storage device of a primary set-top box to one or more other set-top boxes.

2. The method of claim 1, further comprising the step of storing at least a portion of said prerecorded presentation while contacting said headend.

3. The method of claim 1, further comprising the step of storing at least a portion of said prerecorded presentation prior to contacting said headend.

4. The method of claim 1, further comprising the step of storing at least a portion of said prerecorded presentation after securing permission to use said prerecorded presentation.

5. The method of claim 1, further comprising the step of limiting the number of times said prerecorded presentation stored on said storage device can be played to said one or more other set-top boxes.

6. The method of claim 1, further comprising the step of restricting the amount of time said prerecorded presentation stored on said storage device is available to be played to one or more other said set-top boxes.

7. The method of claim 1, wherein said transmitting step is initiated once contact is made with said headend.

8. The method of claim 1, wherein said contacting step comprises said primary set-top box with said storage device contacting said headend to secure permission for said one or more other set-top boxes to receive at least a portion of said prerecorded presentation stored on said storage device of said primary set-top box.

9. The method of claim 1, wherein said contacting step further comprises one of said other set-top boxes requesting said primary set-top box to contact said headend to request permission for said primary set-top box to transmit said prerecorded presentation stored on said primary set-top box to one of said other set-top boxes.

10. The method of claim 1, further comprising the step of contacting the headend to secure additional permission to re-transmit said prerecorded presentation to one of said other set-top boxes.

11. The method of claim 1, further comprising the step of contacting the headend to secure additional permission to re-record at least a portion of said prerecorded presentation to said storage device.

12. A method for obtaining permission to transmit a prerecorded presentation from a DVD to a portable device, said method comprising the steps of:
contacting a headend from a networked multi-room system (NMS) to secure permission for use of said prerecorded presentation; and
in response to securing permission, transmitting at least a portion of said prerecorded presentation stored on a storage device of a set-top box of said NMS to said portable device.

13. The method of claim 12, further comprising the step of storing at least a portion of said prerecorded presentation while contacting said headend.

14. The method of claim 12, further comprising the step of storing at least a portion of said prerecorded presentation prior to contacting said headend.

15. The method of claim 12, further comprising the step of storing at least a portion of said prerecorded presentation after securing permission to use said prerecorded presentation.

16. The method of claim 12, further comprising the step of limiting the number of times said prerecorded presentation stored on said storage device can be played to said portable device.

17. The method of claim 12, further comprising the step of restricting the amount of time said prerecorded presentation stored on said storage device is available to be saved to said portable device.

18. The method of claim 12, wherein said transmitting step is initiated once contact is made with said headend.

19. The method of claim 12, wherein said contacting step comprises a primary set-top box with said storage device contacting said headend to secure permission for said portable device to receive at least a portion of said prerecorded presentation stored on said storage device.

20. The method of claim 12, further comprising the step of contacting the headend to secure additional permission to re-transmit said prerecorded presentation to said portable device.

21. The method of claim 12, further comprising the step of contacting the headend to secure additional permission to re-record at least a portion of said prerecorded presentation to said storage device.

22. The method of claim 12, wherein one or more remote set-top devices in said NMS requests a primary set-top box to download said prerecorded presentation to said portable device.

23. The method of claim 12, wherein said portable device requests to download said prerecorded presentation via a primary set-top box of said NMS contacting said headend.
